(19) United States
(12) Patent Application Publication
(10) Pub. No.: US 2026/0257455 A1
(43) Pub. Date: Sep. 3, 2026

(54) THERMAL SHIELDING DEVICE, MATERIALS, AND METHODS THEREOF

(71) Applicant: Productive Research LLC, West Bloomfield, MI (US)

(72) Inventors: Bryan Joseph TULLIS, Commerce Twp, MI (US); Shimon Mizrahi, Haifa (IL); Eyal Mizrahi, West Bloomfield, MI (US)

(21) Appl. No.: 19/163,553

(22) PCT Filed: Mar. 1, 2024
(86) PCT No.: PCT/US2024/018104

§ 371 Date: Sep. 9, 2025

Related U.S. Application Data
(60) Provisional application No. 63/451,306, filed on Mar. 10, 2023.

(51) Int. Cl. B32B 15/08; B32B 7/027; B32B 7/12; B32B 15/14; B32B 15/16; B32B 15/18; B32B 15/20; H01M 10/658

(52) U.S. Cl. CPC B32B 15/08; B32B 7/027; B32B 7/12; B32B 15/14; B32B 15/16; B32B 15/18; B32B 15/20; H01M 10/658; B32B 2250/04; B32B 2307/206; B32B 2307/304; B32B 2311/24; B32B 2311/30; B32B 2457/10; H01M 2220/20

(57) ABSTRACT

The teachings herein relate to thermal shielding devices for reducing and/or delaying heating of a region near a heat source. The thermal shielding device includes a polymeric core layer interposed between metal layers and a barrier layer. Preferably, the barrier layer provides a thermal barrier, an electrical barrier or both.

### CLAIM OF PRIORITY

The present application claims the benefit of priority of U.S. Provisional Patent Application No. 63/451,306 filed on Mar. 10, 2023, incorporated herein by reference in its entirety.

### FIELD

The teachings herein are directed to composite materials, material systems, and thermal shielding devices for reducing the flow of thermal energy and/or for reducing electrical conductivity. The thermal shielding device includes or is formed of a composite material comprising two metal layers separated by a core layer. The thermal shielding device includes a barrier layer that provides a further thermal barrier and/or conductive barrier. The composite material may include the barrier layer (for example, the barrier layer may be adhered to or attached to the composite material) or the barrier layer may be provided as a separate, unattached material. Preferably, the composite material is a multi-layered material including the barrier layer.

### BACKGROUND

Heat shields typically are made from sheets of metal with the sole purpose of providing a direct barrier for the propagation of a flame from one side of the heat shield to the other side of the heat shield. However, in some applications, there is also a need to also reduce the flow of heat from one side of the heat shield to the other side of the shield. As the heat shields are typically made of metals having high thermal conductivity, heat quickly flows from one side to another. This may be problematic particularly where there is minimal space on the “cool” side between the heat shield and objects which needs to be protected. An example is in a vehicle powered by battery cells, where there is limited spacing between the battery cells and a passenger compartment.

Electrical arcing between a battery cell and a metal layer of a shield may result in rapid heating of the shield, and even disintegration of the shield. Although such heating or disintegration may initially be localized, over a short time period the affected region may quickly expand so that the shield is no longer effective.

As vehicle batteries increase in capacity and/or size, the weight of heat shield generally increases. This weight can affect the vehicle performance, particularly with respect to energy efficiency.

Thermal shielding devices including a composite materials having a polymeric core that reduces thermal conductivity through the composite material, or absorbs thermal energy via an endothermic reaction, or expands in thickness (e.g., via generation of a gas) are described in U.S. patent application Ser. No. 17/628,346, filed on Jan. 19, 2022 by Tullis et al. and published as US 2022/0258453 A1 (the contents of which are incorporated by reference in its entirety).

There continues to exist a need for materials, material systems, thermal shielding devices, and methods for improving on one or any combination of the following features: reduced flow of heat through the material or device device, reduced thermal conductivity of the material or device, reduced weight of the material or device, ability to expand in thickness more than from thermal expansion coefficient of the material or device, ability to absorb thermal energy via an endothermic reaction, ability to retard a flame, ability to reduce sound transmission, ability to provide electrical insulation, or reduce or eliminate electrical arcing.

### SUMMARY

One or more of the above needs are solved with the laminate materials, thermal shielding devices, methods, systems, and battery covers according to the teachings herein.

One aspect of the invention is directed to a laminate and or a thermal shielding device comprising: a first metal layer; a second metal layer; a core layer (preferably an expandable core layer) interposed between the first metal layer and the second metal layer; and a barrier layer that provides a thermal barrier (e.g. thermal insulation), an electrical barrier (e.g., electrical insulation), or both.

Another aspect of the invention is directed at a material system comprising a laminate or other composite material including a first metal layer; a second metal layer; and a core layer (preferably an expandable core layer) interposed between the first metal layer and the second metal layer; wherein the material system includes a barrier layer that provides a thermal barrier (e.g. thermal insulation), an electrical barrier (e.g., electrical insulation), or both. The barrier layer and the laminate may be provided as separate material; the laminate preferably includes the barrier layer. The laminate preferably is in the form of a coil, and more preferably, the coil (e.g., each layer of the coil) is sufficiently ductile so that the laminate can be stamped.

The above aspects of the invention may be further characterized by one or any combination of the following: the barrier layer is directly adjacent to the first metal layer or the insulting layer is attached to the first metal layer; the barrier layer is attached to first metal layer with an adhesive (e.g., a pressure sensitive adhesive); the core layer and the first metal layer are interposed between the second metal layer and the barrier layer (e.g., wherein the layers are arranged in the following sequence: the barrier layer, the first metal layer, the core layer, and the second metal layer); the barrier layer is an outside layer of the device (e.g., facing towards one or more battery cells); the barrier layer and the core layer are interposed between the first metal layer and the second metal layer (e.g., wherein the layers are arranged in the following sequence: the first metal layer, the barrier layer, the core layer, and the second metal layer; the barrier layer includes a composition including an aerogel; the barrier layer includes a high resistivity coating; the high resistivity coating includes a PVC; the high resistivity coating includes a plastisol; the high resistivity coating includes a flame retardant and/or a charring agent; the high resistivity coating is applied as a coating including one or more solvents; the barrier layer includes a composite material comprising inorganic fibers; the inorganic fibers include glass fibers, the composite material comprises a silicon rubber, or preferably both; the composite material includes one or more layers (e.g., two or more layers, or three or more layers) of the silicon rubber and one or more layers (e.g., two or more layers, or three or more layers) of the glass fiber; the barrier layer includes one or more inorganic compounds; the one or more inorganic compounds includes a mineral filler; the mineral filler includes a silicate, preferably an aluminum silicate; the barrier layer includes a mica sheet; the barrier layer includes a flame retardant coating, preferably a flame retardant coating comprising a carbon powder additive; the flame retardant coating has fire endurance on aluminum of 6 hours or more, when tested at 700° C. (preferably when tested at 800° C., more preferably when tested at 900° C., and most preferably when tested at 982.2° C.); the barrier layer includes an expandable graphite; the aerogel includes a carbon aerogel, a silica aerogel, an alumina aerogel, a chromia aerogel, a graphene aerogel, or a tin oxide aerogel; the aerogel has a thermal conductivity of about 0.400 W/mK or less, preferably about 0.070 W/mK or less, more preferably about 0.040 W/mK or less, even more preferably about 0.025 W/mK or less, and most preferably about 0.021 W/mK or less, measured at about 23° C.; the barrier layer is sufficiently ductile so that the thermal shielding device can be formed by stamping the layers and/or so that the thermal shielding device can be wound on a roll; the barrier layer is attached to the first metal layer with an adhesive, preferably including a pressure sensitive adhesive; the core layer is a polymeric core layer including a first additive selected from the group of a flame retardant compound and a gas generating compound or a second additive selected from the group consisting of an antioxidant, a reinforcing filler and a mineral filler; the polymeric core layer includes the first additive and the second additive; the core layer is a polymeric core layer including one or more gas generating compounds that generates a gas (preferably, carbon dioxide or water) at a temperature of about 100° C. to about 320° C.; the first metal layer and the second metal layer are formed of the same material (preferably steel or aluminum); the first metal layers and the second metal layers are formed of different materials (e.g., the first metal layer is one of a steel layer or an aluminum layer and the second metal layer is the other); a ratio of a thickness of the second metal layer to a thickness of the first metal layer is about 1.4 or more; the thermal shielding device has a thermal conductivity of about 0.015 to about 4 W/mK; upon heating to a temperature of about 100° C. or more, the core layer causes a separation distance between the first and second metal layers to increase in one or more regions and a thickness of the thermal shielding device to increase by about 15 percent or more in the one or more regions; the polymeric core layer generates or releases a sufficient amount of gas at an elevated temperature (e.g., about 100° C. or more, about 200° C. or more, about 250° C. or more, or about 350° C. or more) to cause the separation of the metal layers and the increase in the thickness of the thermal shielding device in the one or more regions; the core layer includes a compound having one or more waters of hydration; the core layer is formed of a material, excluding any voids and/or pores in the core layer, having a density of about 0.90 to about 2.00 g/cm³ at a temperature of about 25° C.; the core layer includes a polymer, and the thermal shielding device includes a catalyst that accelerates a degradation of the polymer, preferably so that the pressure between the metal layers is increased; the thermal shielding device has a thickness of about 0.70 mm to about 5.0 mm; a ratio of a thickness of the core layer to a thickness of the thermal shielding device is about 0.15 to about 0.45; a ratio of a thickness of the barrier layer to a thickness of the thermal shielding device is about 0.15 to about 0.45; or the thermal shielding device has an area of about 0.05 m² or more and/or about 20.0 m² or less.

Another aspect of the invention is directed at a battery cover, preferably for a plug-in electric vehicle, comprising a thermal shielding device and or a laminate including a barrier layer according to the teachings herein.

Another aspect of the invention is directed at the use of a battery cover according to the teachings herein in an automotive vehicle. Preferably the battery cover includes a laminate having a polymeric core layer having a thermal conductivity of about 0.05 to about 4 W/mK. Preferably, the battery cover is positioned between a vehicle battery that provides power for an electric motor that drives the vehicle and a passenger compartment.

A further aspect of the invention is directed at a system comprising a battery cover according to the teachings herein; an electric motor for driving one or more wheels of a vehicle; one or more battery cells for providing power to the electric motor; wherein the battery cover is arranged over one or more of the battery cells. Preferably wherein the battery cover is generally horizontal. Optionally, the battery cover is attached to a container that holds one or more battery cells and/or the battery cover is attached to a vehicle body and arranged below a passenger compartment. Optionally system includes a gap above or below the battery cover for allowing a separation of the first and second metal layers to increase.

This aspect of the invention may be further characterized by one or any combination of the following the battery cover is arranged so that the barrier layer faces towards the one or more battery cells; or the barrier layer has a sufficiently high electrical resistivity to prevent or reduce arcing or other electrical failure.

Another aspect of the invention is directed at a method for forming a thermal shielding device, comprising a step of stamping or blanking a material system or a laminate according to the teachings herein.

Another aspect of the invention is directed to a method of applying a material system to a battery comprising a step of: positioning a barrier layer over a housing including one or more battery cells, positioning a laminate or other composite material over the barrier layer, and attaching the laminate to the housing.

### BRIEF DESCRIPTION OF THE DRAWINGS

FIG. 1 is an illustrative cross-sectional view of a laminate that is free of a barrier layer.

FIG. 2 is an illustrative cross-sectional view of a thermal shielding device, or section of a thermal shielding device including a laminate having a first metal layer interposed between a barrier layer and a core layer.

FIG. 3 is an illustrative cross-sectional view of a thermal shielding device, or section of a thermal shielding device including a laminate having a barrier layer interposed between a first metal layer and a core layer.

FIG. 4 is an illustrative cross-sectional view of a thermal shielding device, or section of a thermal shielding device including a laminate having two or more barrier layers.

FIG. 5 is an illustrative cross-sectional view of a thermal shielding device, or a section of a thermal shielding device including a laminate having an adhesive layer for attaching the barrier layer to the laminate (e.g., to the first metal layer).

FIG. 6 is an illustrative cross-sectional view of a thermal shielding device, or a section of a thermal shielding device including a laminate and a separate barrier layer (i.e., where the barrier layer is unattached to the laminate).

FIG. 7 is a top view of a thermal shielding device showing one or more shielding regions and one or more extension regions. The extension regions may be formed of the same material as material of the shielding region or may be formed of a different material.

FIG. 8 is a top view of a thermal shielding device showing one or more attachment locations located at or near an edge region of device.

FIG. 9 is a side cross-section view of a thermal shielding device showing the layers of a composite material in a shielding region and one or more bent portions, protrusions, or extensions that are angled relative to the shielding region. A bent portion, protrusion, or extension may be made of the composite material or of a different material.

FIG. 10 is an illustrative side view cross-section showing a thermal shielding device being expanded during an extreme thermal event. As illustrated in FIG. 5, an edge of the composite material may be sealed. For example, the two metal layers may be welded, joined or otherwise sealed at their common edges.

FIG. 11 is an illustrative cross-sectional view of an edge region.

FIG. 12A is a cross-sectional view of an illustrative edge region of a thermal shielding device showing an attachment of the device.

FIG. 12B shows features of FIG. 12A after a core layer has expanded (e.g., during or after an extreme thermal event).

FIG. 13 is a cross-sectional view of an illustrative edge region having a break point.

FIG. 14 is a cross-sectional view showing local expansion of a thermal shielding device due to an extreme thermal event.

FIG. 15 is a cross-sectional view showing a composite material of a thermal shielding device having a component for storing potential energy, such as in one or more compressed springs.

FIG. 16 is a cross-sectional view showing a composite material of a thermal shielding device having a metal layer capable of expanding in one or more regions without yielding the metal layer.

FIG. 17 illustrates the exposure of the thermal shielding device of FIG. 16 to heat and the melting or softening of the polymer in a region of the core layer.

FIG. 18 illustrates the local expansion of the thermal shielding device of FIG. 17. Preferably, a separation distance between the two metal layers increases without yielding of the metal layer.

FIG. 19A is a cross-sectional view showing the formation of a composite material for a thermal shielding device using one or both metal layers that are curved.

FIG. 19B shows the composite material after forming, where the composite material includes potential energy from the metal layer(s) being in a compressed state.

FIG. 20A illustrates an edge covering component having one or more features for expanding the component without yielding a material of the covering component.

FIG. 20B illustrates the edge covering component of FIG. 20A after the core layer has expanded. Preferably the covering component seals the edge before and/or after expansion of the core layer.

### DETAILED DESCRIPTION

The thermal shielding device preferably is constructed so that the heat flow through the thermal shielding device is reduced or minimized and/or so that electrical arcing is reduced or eliminated. The thermal shielding device according to the teachings herein includes a composite material having a first metal layer and a second metal layer which are separated by a polymeric core layer, and further comprises a barrier layer. The materials of the composite material may be selected so that the thermal conductivity of the composite material in the thickness direction (i.e., going through the two metal layers and the polymeric core layer) is reduced relative to thermal conductivity of the first metal layer, the second metal layer or both. The barrier layer may provide a thermal barrier (e.g., thermal insulation), an electrical barrier (e.g., an electrical insulation), or both. The core layer preferably includes a flame retardant compound or a gas generating compound. The combination of the core layer and the barrier layer results in improved shielding performance, particularly for heat and/or arcing from electric batteries. Furthermore, improved performance may be attained while maintaining low weight by using core layer and barrier layer materials having relatively low density (e.g., compared to the metal layers). The combination of low weight and improved thermal insulation and/or electrical insulation may be particularly important in shielding of vehicle batteries.

The thermal shielding device preferably is designed so that the spacing between the metal layers may increase when the device is exposed to high temperatures, such as during an extreme thermal event as discussed herein. The separation of the metal layers may function to further reduce heat flow through the thermal shielding device.

The thermal shielding device may include one or more features that results in an endothermic reaction upon heating, so that heat transfer through the thermal shielding device is reduced.

The thermal shielding device may include one or more features that prevents or delays the polymeric core layer from burning and thus helps delay the amount of heat transferred through the device.

Although various approaches to reduce the heat transfer are discussed herein, it will be appreciated that multiple approaches may be combined to achieve further improvements.

The materials for the thermal shielding device may also be selected to achieve reduced density, particularly when the device is used in an automotive vehicle, and especially when the automotive vehicle is powered by an electric motor, such as in a plug-in electric vehicle.

### Extreme Thermal Event

Extreme thermal event refers to an event that causes a temperature directly adjacent to the heat shielding device and/or on one surface of the heat shielding device to increase to a critical temperature, above a normal operating temperature. The critical temperature may be about 80° C. or more, about 120° C. or more, about 160° C. or more, about 190° C. or more, or about 210° C. or more. The critical temperature may be about 600° C. or less, about 500° C. or less, about 400° C. or less, or about 300° C. or less.

The extreme thermal event may occur due to any event or situation that causes the temperature to reach or rise above the critical temperature. Examples of such events include a fire, a battery or battery cell failure, a mechanical failure resulting in generation of frictional energy, a failure of a cooling device, and the like. The extreme thermal event may be a catastrophic event where one or more components have failed.

During an extreme thermal event, there may be a need to reduce the flow of heat in one or more directions. Reducing the flow of heat may be a needed to prevent further damage and/or to provide additional time for responding to the event.

Unless otherwise stated, the dimensions and properties of the thermal shielding device refer to the dimensions at ambient conditions (i.e., about 25° C.) prior to an extreme thermal event which may change one or more dimensions of the device.

FIG. 1 is a cross-sectional view of an illustrative laminate 10 comprising a first metal layer 12, a second metal layer 14, and a core layer 16 interposed between the first metal layer and the second metal layer.

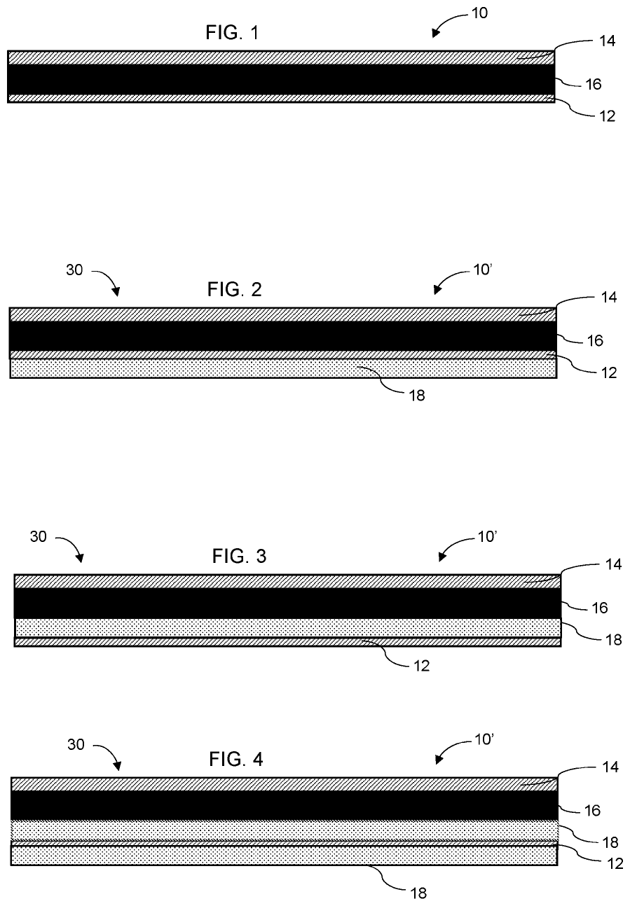

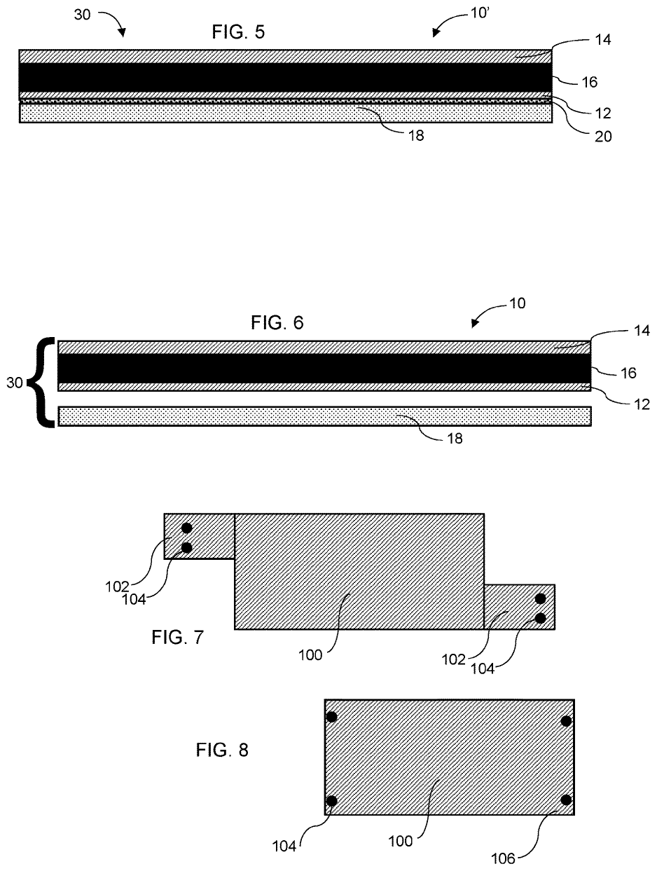

FIGS. 2, 3, 4, and 5 are cross-sectional view of illustrative thermal shielding devices 30 (or portions of such devices) including a laminate 10′ comprising a barrier layer 18. A barrier layer 18 may be adjacent to, in direct contact with, or attached to the first metal layer, such as illustrated in FIGS. 2, 3, 4, and 5. A barrier layer 18 may be interposed between the first metal layer and the second metal layer and/or between the first metal layer and the core layer, such as illustrated in FIGS. 3 and 4. The first metal layer 12 may be interposed between a barrier layer and the core layer, such as illustrated in FIGS. 2, 4 and 5. The laminate may include one or more barrier layers, or may include two or more barrier layers. The laminate may include a first metal layer interposed between two barrier layers, such as illustrated in FIG. 4. A barrier layer 18 may be attached to a metal layer using an adhesive 20, such as illustrated in FIG. 5. A barrier layer 18 may be provided as a separate component to a laminate 10, such as illustrated in FIG. 6. For example, the barrier layer may be arranged underneath the laminate 10 during assembly or during installation of a heat shielding device 30. However, it is preferred that the barrier layer 18 is attached to the first metal layer so that the barrier layer can be processed (e.g., including stamping, blanking, rolling, storing, shipping, installing, forming, or any combination thereof) with the other layers of the thermal shielding device.

The core layer preferably is a polymeric core layer including one or more polymers. The metal layers may have the same thickness or may have different thicknesses. The metal layers may be formed of the same metal or may be formed of different metals. Preferably, the first and second metal layers are formed of an aluminum or a steel. More preferably, the first metal layer is formed of an aluminum. Preferably, the first and second metal layers are formed of metals having about the same coefficient of thermal expansion (for example, the ratio of the coefficients of thermal expansion at about 500° C. may be from 0666 to 1.500, from about 0.80 to about 1.25, from about 0.90 to about 1.1, or from about 0.95 to about 1.05, or from about 0.98 to about 1.02). Preferably the first and second metal layers are both formed of the same metal, and more preferably the first and second metal layers are both formed of an aluminum. The thermal shielding device may include one or more adhesive layers. An adhesive layer may be employed to adhere or otherwise join two other layers together. It will be appreciated that a core layer may include an adhesive for adhering to a metal layer and/or for adhering to a barrier layer. The metal layers may have a coating on one or more surfaces for protecting the surface and/or for improving the adhesion of the metal layer to the core layer. The metal layers may have a coating on one or more surfaces (preferably an exterior surface facing towards a heat source or battery cells) which reduces heat flow and/or heat generation. For example, the coating includes a flame retardant (preferably a polymer including a flame retardant), a nano-coating (preferably that is thermally conductive but electrically insulating), or both. Particularly preferred coating is a coating including a flame retardant. The core layer preferably is attached to the first metal layer, to the second metal layer, or both. The attachment preferably includes adhesion or bonding directly or indirectly between the core layer and the metal layer(s). The core layer may include a polymer or an additive that improves the adhesion to one or both metal layers. One or both metal layers may be covered with an adhesive layer and/or a primer layer for providing adhesion to the core layer.

The thermal shielding device according to the teachings herein includes a first metal layer, a second metal layer, a core layer interposed between the first metal layer and the second metal layer, and one or more barrier layers. The barrier layer may provide a thermal barrier (e.g., thermal insulation), an electrical barrier (e.g., electrical insulation) or both. The thermal shielding device may provide a direct barrier for reducing or eliminating the propagation of heat or flame from one side of the shielding device to the other side (e.g., opposing side or opposing face surface). For example, a component that generates heat or flame may be located on a first side of the thermal shielding device and/or a component or compartment which is to be protected from the heat or flame is located on the second side of the thermal shielding device. Typically, the location of the first metal layer in the thermal shielding device is towards the first side (i.e., towards the component that generates heat or flame) and the location of the second metal layer is towards the second side of the thermal shielding device. Preferably, a barrier layer is interposed between the first and second metal layers, or the first metal layer is interposed between the barrier layer and the core layer. If a barrier layer is interposed between the first and second metal layers, it may also be interposed between the first metal layer and the core layer, or between the second metal layer and the core layer.

The laminate may be in the form of a coiled structure. For example, a coil of the laminate may be produced, stored or transported. The laminate may be unwound from the coil and/or cut into blanks for forming the thermal shielding device. Alternatively, the laminate may be in the form of a sheet. For example, a sheet of the laminate may be produced, stored or transported. The sheet may be cut into blanks for forming the thermal shielding device.

The layers of the thermal shielding device may be arranged in the following sequence: the barrier layer, the first metal layer, the core layer, and the second metal layer. The layers of the thermal shielding device may be arranged in the following sequence the first metal layer, the barrier layer, the core layer, and the second metal layer. Preferably the thermal shielding device includes or is formed of a laminate that includes, two or more, three or more, or all of the layers selected from the group consisting of the first metal layer, the second metal layer, the core layer, and the barrier layer. The laminate may optionally include one or more adhesive layers for adhering two other layers together. By way of example, an adhesive layer may be used to adhere a metal layer to the core layer, and/or an adhesive layer may be used to adhere a barrier layer to a metal layer, and/or an adhesive layer may be used to adhere a barrier layer to a core layer.

The barrier layer may be attached by an adhesive to a laminate including the first metal layer. The barrier layer may be attached directly to the first metal layer by an adhesive. For example, a pressure sensitive adhesive may adhere the barrier layer to the laminate (e.g., to the other layers of the laminate) and/or to the first metal layer.

A barrier layer may provide a thermal barrier (e.g., thermal insulation), an electrical barrier (e.g., electrical insulation) or both. Without limitation, examples of barrier layers include compositions containing an aerogel, composite materials including inorganic fibers, materials including or consisting of one or more inorganic compounds, materials including or consisting of a graphite, a flame retardant coating, a high resistivity coating, or any combination thereof. The barrier layer may be monolithic, a composite, or a material having multiple layers. If the barrier layer includes multiple layers, two of the layers may be formed of the same material or of different materials.

A barrier layer may include, consist essentially of, or consist entirely of a flame retardant coating. The flame retardant coating may protect a metal surface from the impact of a flame. For example, the flame retardant coating may be applied to an aluminum surface. Without the flame retardant coating, the metal (e.g., the aluminum) may fail when exposed to a flame for an extended time (e.g., about 6 hours), with a temperature of about 700° C., about 800° C., about 900° C. or about 982.2° C. The failure typically is in the form of a hole in the 1.5 mm metal sheet. The flame retardant coating may allow for exposure of the flame for 6 hours (at a temperature of about 700° C., about 800° C., about 900° C. or about 982.2° C., without failure of the heat shielding device (e.g., without burn through), where the total thickness of the metal layers in the heat shielding device is about 1.4 mm or less (preferably about 1.3 mm or less, more preferably about 1.2 mm or less, and even more preferably about 1.1 mm or less) and/or where the total weight of the heat shielding device is less than the weight of a metal (e.g., aluminum or steel) of 1.5 mm thickness and the same shape (e.g., same width and thickness as the heat shielding device). The flame retardant coating may include a low density fiber, a cementitious compound, an intumescent coating, a gypsum, a carbon powder additive, or a cement. The flame retardant coating may include one or more polymers, such as one or more thermosetting resins.

A barrier layer may include or consist of a layer of a graphite. Preferred graphite layerss are expandable graphites. The graphite may be expanded after a laminate including the first metal layer and the graphite layer is formed (e.g. after a laminate include the first and second metal layers, the core layer and the graphite layer is formed). The graphite may be expanded before the graphite layer is attached to the first metal layer or before assembling the graphite layer with a laminate including the first metal layer. The graphite preferably is expanded by treating the graphite with an oxidizing agent. The graphite may have an expansion ratio of about 30 or more, about 50 or more, about 70 or more, about 90 or more, about 110 or more, about 130 or more, or about 140 or more. The graphite may have an expansion ratio of about 250 or less, about 200 or less, or about 175 or less.

A barrier layer may include or consist of a layer formed of a material including inorganic fibers. The inorganic fibers may be woven or unwoven. The inorganic fibers may include fibers that are preferentially oriented in one or more directions. The inorganic fibers may include fibers that are randomly oriented. The inorganic fibers may include fibers that are short (e.g., less than about 5 cm in weight average length), intermediate length (e.g., about 5 cm to about 20 cm in weight average length) or long (e.g., greater than about 20 cm in weight average length). A preferred inorganic fiber is a glass fiber. The glass fibers may be provided in one or more layers. For example, the barrier layer may include two or more layers of glass fibers. Preferably, the barrier layer including the inorganic fibers is a composite including one or more layers of a polymeric material. Preferably, adjacent layer of glass fibers are separated by a polymeric material. The polymeric material may be a thermoplastic material, a thermosetting material, or a rubber material. The polymeric material preferably includes a synthetic polymer. The polymeric material preferably includes or consists of an inorganic polymeric material, such as a silicon-based polymer. A preferred silicon-based polymer is a silicon rubber. For example, the barrier layer may include multiple layers of glass fiber that are separated by layers of a silicon-based polymer (e.g., a silicon rubber). The composite material including inorganic fibers may include one or more layers, two or more, or three or more layers of silicon rubber and one or more layers, two or more layers, or three or more layers of glass fibers. The composite material for the barrier layer preferably has a thickness of about 0.2 mm or more, about 0.4 mm or more, about 0.6 mm or more, or about 0.7 mm or more. In order to reduce cost and/or weight, it is preferred that the composite material for the barrier layer has a thickness of about 3.0 mm or less, about 2.5 mm or less, about 2.1 mm or less, about 1.8 mm or less, or about 1.7 mm or less. For example, the thickness of the composite barrier layer (e.g., glass/silicon-based polymer composite) may be about 0.70 to about 1.10 mm, about 0.90 to about 1.30 mm, about 1.10 to about 1.50 mm, about 1.30 to about 1.70 mm, about 1.50 to about 1.90 mm, about 1.70 to about 2.10 mm, about 1.90 to about 2.30 mm, or about 2.1 to about 3.0 mm. The barrier layer (e.g., composite material) preferably has a density of about 1.40 g/cm³ or more, or about 1.50 g/cm³ or more, or about 1.55 g/cm³ or more, measured according ISO 2781. The density of the barrier layer (e.g., composite material) preferably is about 1.80 g/cm³ or less, or about 1.70 g/cm³ or less, or about 1.65 g/cm³ or less, measured according ISO 2781. The barrier layer (e.g., composite material) preferably has one or more of the following characteristics: a V1 flammability rating as measured according to UL94-V1; no burn through at 1000° C. after 30 minutes (oxyacetylene flame and/or oxygen propane flame); thermal conductivity of less than 0.3 W/mK as measured according to ASTM D 5470; dielectric strength of about 10 kv/mm or more, as measured according to ASTM D149; or a hardness (durameter) of about 90 Shore A or less (preferably about 82 Shore A or less), as measured according to ISO 48-4. Examples of composite materials which may be used for a barrier layer include Thermal Barrier MK-315 (having 3 layers of woven glass and two layers of elastomer, with a thickness of about 1.5 mm), Thermal Barrier MK-108 (having 1 layer of wowen glass and 1 layer of elastomer, with a thickness of about 0.80 mm), commercially available from NB Materials Co., Ltd.

The barrier layer of the thermal shielding device may include a high resistivity coating layer. The high resistivity coating layer comprises a thermoplastic composition, preferably including a thermoplastic polyvinyl chloride (PVC). The thermoplastic composition may be applied as a coating including one or more solvents. The one or more solvents preferably includes one or more aromatic solvents, one or more alcohols, one or more ketones, one or more alkanes, or any combination thereof. The one or more solvents preferably includes one, two, three, four, or all of toluene, phenol, an n-alcohol having 3 to 6 carbon atoms (preferably having 3 or 4 carbon atoms), ethyl alcohol, and a ketone (e.g., a branched ketone). The thermoplastic composition preferably includes a plasticizer. The concentration of the plasticizer in the thermoplastic composition preferably is sufficiently high so that the barrier layer can be processed by stamping, bending, drawing, or other forming process without fracture or delamination of the barrier layer. The thermoplastic composition including the PVC preferably comprises a flame retardant, a charring agent, or both. The total concentration of the PVC, the flame retardant and/or charring agent, and any plasticizer is about 98 weight percent or more, about 99 weight percent or more, about 99.5 weight percent or more, or about 99.8 weight percent or more, or about 100 weight percent, based on the total weight of the barrier layer.

The thermal shielding device (e.g., the barrier layer) according to the teachings herein may include a layer of a composition including an aerogel. The aerogel containing composition preferably is interposed between the first metal layer and the core layer, or the aerogel is interposed between the second metal layer and the core layer, or the first metal layer is interposed between the core layer and the aerogel. More preferably, the aerogel containing composition is interposed between the core layer and the first metal layer or the first metal layer is interposed between the core layer and the aerogel. Most preferably, the aerogel containing composition directly contacts or is attached to the first metal layer. Typically, aerogels are ultralight weight solid materials having a porosity of about 75 percent by volume or more, about 86 volume percent or more, about 94 volume percent or more, or about 97 volume percent or more. The porosity of the aerogel may be about 99 volume percent or less, or about 98 volume percent or less. Aerogels may be formed from a gel having a liquid component, and replacing the liquid component with a gas. Preferably, at least 80 weight percent, at least about 90 weight percent, at least about 95 weight percent, at least about 98 weight percent, at least about 99.5 weight percent, or about 100 weight percent of the liquid component is replaced with the gas. The composition including an aerogel is preferably an intumescent material which expands upon heating. For example, composition including an aerogel material may be included in the thermal shielding device and the composition may be activated by a thermal event in a component that is being shielded, thus activating the aerogel containing composition and causing expansion. Without limitation, the aerogel may include a carbon aerogel, a silica aerogel, an alumina aerogel, a chromia aerogel, a graphene aerogel, a tin oxide aerogel, or any combination thereof. The aerogel may include or consist essentially (e.g., at least about 70 wt. %, at least about 80 wt. %, at least about 90 wt. %, at least about 95 wt. %, at least about 99 wt. %, or about 100 wt. %) of carbon atoms (optionally some or all in the form of graphene), silicon atoms, aluminum atoms, tin atoms, chromium atoms, oxygen atoms, or any combination thereof. The aerogel or the composition including the aerogel preferably has a thermal conductivity (measured at 23° C.) that is less than the thermal conductivity of the core layer. The thermal conductivity (measured at 23° C.) if the aerogel may be about 0.400 W/m·° K. or less, preferably about 0.070 W/m·° K., more preferably about 0.040 W/m·° K. or less, even more preferably about 0.025 W/m·° K. or less, and most preferably about 0.021 W/m·° K. Preferably, the barrier layer including the aerogel material expands at a temperature of about 200° C. or more, about 250° C. or more, about 300° C. or more, or about 350° C. or more. The expansion of the barrier layer including the aerogel preferably is about 200 volume percent or more, more preferably about 300 volume percent or more, even more preferably about 400 volume percent or more, and most preferably about 500 volume percent or more. The volume expansion preferably is about 1500% or less, about 1000% or less, or about 750% or less, although higher levels of expansion may be employed. The barrier layer including the aerogel may include a binder, an oligomeric material (e.g., having a molecular weight of less than 8,000, or about 4,000 or less) or less), or a polymeric material (e.g., having a molecular weight of 8,000 or more, or about 20,000 or more, or about 40,000 or more). The barrier layer including the aerogel may be applied as a coating. Preferred coating materials have a viscosity of about 400 to 12000 cps (measured at 25° C.). The coating material including the aerogel preferably is dry to touch and/or cures in about 48 hours or less, about 24 hours or less, about 12 hours or less, about 6 hours or less, or about 3 hours or less. The drying time may be measured on a coating at 25° C., 50% relative humidity, applied at a thickness of about 0.4 mm using brush application. The coating material including the aerogel preferably has a solids content of about 20 volume percent or more, about 30 volume percent or more, about 40 volume percent or more, or about 50 volume percent or more. The coating material including the aerogel preferably has a solids content of about 80 volume percent or less, about 70 volume percent or less, or about 65 volume percent or less. The barrier layer including the aerogel preferably has a thickness of about 0.10 mm or more, about 0.20 mm or more, about 0.30 mm or more, about 0.4 mm or more, or about 0.50 mm or more, and/or a thickness of about 3.0 mm or less, about 2.0 mm or less, about 1.50 mm or less, about 1.20 mm or less, about 1.10 mm or less, or about 1.00 mm or less. Typical compositions including an aerogel, upon drying and/or curing are brittle and cannot be stamped when applied as a coating. Preferably, the barrier layer including the aerogel (e.g., after drying or curing if applied as a coating layer) is sufficiently ductile so that the thermal shielding device can be processed by stamping, bending, drawing or other forming processes without fracture or delamination of the barrier layer.

A barrier layer for the thermal shielding device and/or the composite material may include one or more inorganic compounds. The inorganic compound preferably includes a mineral filler. The inorganic compound may include a silicate or a mica. The silicate may include or consist essentially of aluminum silicate. The amount of the inorganic compound in the barrier layer may be about 53 weight percent or more, about 66 weight percent or more, about 82 weight percent or more, about 91 weight percent or more, about 97 weight percent or more, about 99 weight percent or more. The amount of the inorganic compound in the barrier layer may be about 100 weight percent or less. The barrier layer may include a mica sheet or a silicate sheet. The inorganic compound may provide increased electrical resistance (e.g., compared to the first metal layer and/or the second metal layer), reduced thermal conductivity (e.g., compared to the first metal layer and/or the second metal layer), or preferably both. The barrier layer including one or more inorganic compounds preferably is sufficiently flexible so that a laminate including the barrier layer can be wound on a roll without cracking or fracturing. Preferably barrier layer can be wound along a roll of about 100 mm, about 200 mm, about 300 mm, about 400 mm, or about 500 mm without cracking or fracturing.

A barrier layer for the thermal shielding device and/or the composite material preferably is sufficiently ductile so that the thermal shielding device can be formed by stamping a laminate including the first metal layer, the second metal layer, the core layer, and the barrier layer. The barrier layer preferably has an elongation at break of about 10% or more, more preferably about 20% or more, even more preferably about 30% or more, and most preferably about 40% or more, as measured according to ISO 37.

A barrier layer for the thermal shielding device and/or the composite material preferably is sufficiently ductile so that the barrier layer and/or a laminate including the metal layer(s), the core layer, and the barrier layer can be wound into a roll (for example on a roll having a diameter of about 100 mm or more, about 150 mm or more, about 200 mm or more, about 250 mm or more, about 300 mm or more, or about 400 mm or more. The barrier layer preferably has a durometer of about 95 Shore A or less, about 91 Shore A or less, about 88 Shore A or less, about 85 Shore A or less, about 82 Shore A or less, or about 79 shore A or less, as measured according to ISO 48-4. The barrier layer preferably has a durometer of about 22 Shore A or more, about 35 Shore A or more, about 45 Shore A or more, or about 60 shore A or more.

The barrier layer should have a sufficient thickness so that it provides the required electrical and/or thermal barrier properties. Preferably, the barrier layer has a thickness of about 0.30 or more. If the barrier layer is too thick, the weight of the thermal shielding device may be too high and/or the cost of the barrier layer may be too high. Preferably, the barrier layer has a thickness of about 4.0 mmm or less, more preferably about 3.0 mm or less, and most preferably about 2.5 mm or less. It will be appreciated that as the cost of the barrier material increases and/or the density of the barrier layer material increases, the upper limit on the thickness of the barrier layer will decrease. For such materials, the thickness of the barrier layer preferably is about 2.2 mm or less, about 1.9 mm or less, about 1.60 mm or less, about 1.40 mm or less, about 1.20 mm or less, about 1.00 mm or less, or about 0.90 mm or less.

The initial thickness (e.g., at about 25° C., and prior to an extreme thermal event) of the thermal shielding device or the laminate preferably is about 0.70 mm or more, more preferably about 0.90 mm or more, and most preferably about 1.20 mm or more. The initial thickness of the thermal shielding device or the laminate preferably is about 6 mm or less, more preferably about 5.00 mm or less, even more preferably about 3.50 mm or less, and most preferably about 3.00 mm or less. The ratio of the initial thickness of the polymeric core layer to the initial thickness of the thermal shielding device or the laminate preferably is about 0.150 or more, about 0.20 or more, about 0.25 or more, or about 0.30 or more and/or about 0.85 or less, about 0.80 or less, 0.75 or less, or about 070 or less, or about 0.60 or less, or about 0.50 or less, or about 0.45 or less. The polymeric core layer preferably has an initial thickness of about 0.30 mm or more, 0.40 mm or more, about 0.60 mm or more, or about 0.80 mm or more. The polymeric core layer preferably has an initial thickness of about 3.00 mm or less, or about 1.90 mm or less, or about 1.3 mm or less, or about 1.0 mm or less. The ratio of the initial thickness of the barrier layer to the initial thickness of the thermal shielding device or the laminate preferably is about 0.150 or more, about 0.20 or more, about 0.25 or more, or about 0.30 or more and/or about 0.60 or less, or about 0.50 or less, or about 0.45 or less. The barrier layer preferably has an initial thickness of about 0.20 mm or more, 0.40 mm or more, about 0.60 mm or more, or about 0.80 mm or more. The barrier layer preferably has an initial thickness of about 4.00 mm or less, or about 3.2 mm or less, or about 2.5 mm or less, or about 2.0 mm or less, or about 1.50 mm or less, or about 1.00 mm or less.

The thermal shielding device preferably has a sufficient area (e.g., in a direction perpendicular or normal to the thickness direction) so that it reduces the heat exposure to one or more devices or one or more components or more compartments. The thermal shielding device preferably has an area of about 0.05 m² or more, about 0.15 m² or more, about 0.45 m² or more, or about 1.85 m² or more. In some applications, the area of the thermal shielding device is about 20.0 m² or less, about 18.0 m² or less, about 16.0 m² or less, about 13.0 m² or less or about 10 m² or less. It will be appreciated that in some applications the area of the thermal shielding device may be greater than 20.0 m². A thermal shielding device may be replaced by two or more smaller sections or components. Each section or component may include a composite material according to the teachings herein.

### Thermal Conductivity

Thermal conductivity of the thermal shielding device is measured in the thickness direction, through the metal layers and the polymeric core layer. The thermal conductivity of the polymer core layer and/or the thermal shielding device preferably is about 4.0 W/mK or less, about 2.00 W/mK or less, about 1.0 W/mK or less, or about 0.80 W/mK or less. Preferably the thermal conductivity of the polymer core layer and/or the thermal shielding device is about 0.05 W/mK or more. The thermal conductivity is preferably measured at a temperature of about 25° C. Unless otherwise specified, the thermal conductivity of the thermal shielding device and/or the polymeric core layer may be measured according to ASTM D 5930 17.

### Reduction in Weight/Density

The core layer and/or the metal layer may be selected to reduce the weight of the thermal shielding device.

The density of the core layer may be about 2.30 g/cm³ or less, about 2.00 g/cm³ or less, about 1.80 g/cm³ or less, about 1.60 g/cm³ or less, about 1.40 g/cm³ or less, or about 1.30 g/cm³ or less. The density of the core layer may be about 0.950 g/cm³ or more or about 1.10 g/cm³ or more.

One or both of the metal layers may be formed of a steel or may be selected to have a density less than steel. Each metal layer may independently be selected to have a density of about 8.0 g/cm³ or less, about 7.7 g/cm³ or less, about 6.8 g/cm³ or less, about 5.6 g/cm³ or less, about 5.0 g/cm³ or less, about 4.6 g/cm³ or less, about 4.1 g/cm³ or less, or about 3.3 g/cm³ or less. The density of the metal layers typically is about 2.5 g/cm³ or more. Particularly preferred metals having density less than steel include aluminum, aluminum alloys including at least 60 atomic percent aluminum atoms (based on the total number of metal atoms), titanium, and titanium alloys.

It will be appreciated that the reduction in weight and/or density may be due in part or even completely to the polymeric core layer. For example, the thickness of the core layer and/or the density of the core layer may be sufficient to result in some or all of the improvements in the weight of the thermal shielding device.

The ratio of the density of the composite material of the thermal shielding device to the average density of the metal layers preferably is about 95% or less, about 90% or less, about 85% or less, about 80% or less, or about 75% or less. The ratio of the density of the composite material of thermal shielding device to the average density of the metal layers may be about 20 % or more, about 30% or more, about 40% or more, or about 50% or more. The average density of the metal layers may be calculated as D_{avg}=(t₁D₁+t₂D₂)/(t₁+t₂), where t₁ and t₂ are the thicknesses of the first and second metal layers, and D₁ and D₂ are the densities of the first and second metal layers.

### Polymeric Core Layer

The polymeric core layer includes one or more polymers. Preferably the polymeric core layer comprises one or more first additives selected from the group consisting of a flame retardant compound and a gas generating compound, and/or one or more second additives selected from the group consisting of an antioxidant, a reinforcing filler and a mineral filler. Preferably, the polymeric core layer includes both the first additive and the second additive.

The amount of polymer in the polymeric core layer should be sufficient so that the polymer forms a continuous phase and/or so that the material of the core layer can be extruded as a filled polymer. Preferably, the amount of the polymer in the polymeric core layer is about 10 weight percent or more, about 12 weight percent or more, about 14 weight percent or more, about 16 weight percent or more, about 18 weight percent or more, or about 20 weight percent or more. Although the core layer may consist entirely of the one or more polymers, the core layer preferably includes one or more non-polymeric components that help reduce heat flow, particularly during an extreme thermal event. As such, the amount of polymer in the core layer preferably is about 95 weight percent or less, about 90 weight percent or less, about 80 weight percent or less, about 70 weight percent or less, about 60 weight percent or less, about 50 weight percent or less, or about 40 weight percent or less.

### Polymers

When the polymer is below its melting temperature or glass transition temperature, it may be difficult to expand when gas is released or generated in the polymeric core layer. As such, the polymer may be selected so that it is molten when gas is released or generated in the polymeric core layer (e.g., during an extreme thermal event).

### Melting temperature

As used herein, the term “melting temperature” refers to the peak melting temperature for a semi-crystalline polymer and to the glass transition temperature to a thermoplastic polymer that is amorphous. In general, the melting temperature gives an indication of the temperature at which the polymer molecules begin to flow. With respect to foaming or gas generation, this melting of the crystals or increase in free volume related to heating above the glass transition temperature results in a polymer that can more readily expand and accommodate pockets of gas.

If the melting temperature of the polymer is too low, the thermal shielding device may fail due to melting or softening of the polymer during normal use. The melting temperature preferably of the polymer preferably is about 90° C. or more, more preferably about 100° C. or more, even more preferably about 110° C. or more, and most preferably about 120° C. or more. The melting temperature of the polymer should be sufficiently low so that the polymer is above the melting temperature when the gas is being generated or released in the polymeric core layer (e.g., as a result of an extreme thermal event). The temperature of the polymer preferably is about 300° C. or less, more preferably about 240° C. or less, even more preferably about 200° C. or less, even more preferably about 170° C. or less, and most preferably about 145° C. or less. Glass transition temperature and peak melting temperature may be measured using differential scanning calorimetry at a heating rate of 10° C./min.

The polymer may melt or softens at a temperature near or below (preferably below) the activation temperature of a blowing agent. When the blowing agent activates due to thermal energy (e.g., during an extreme thermal event), the polymer foams. The polymer foam may be characterized by open cells, closed cells, or both. The pressure from the activated blowing agent and/or the foam may cause the metal layers to separate.

The polymeric core layer, prior to any extreme thermal event, may be a generally dense material. For example, the amount of any voids and/or pores in the polymeric core layer (and/or between the metal layers) may be about 15 volume percent or less, about 10.0 volume percent or less, about 5.0 volume percent or less, about 3.0 volume percent or less, or about 1.5 volume percent or less, based on the total volume of the polymeric core layer (and/or the space between the metal layers). The dense material may have about 0 volume percent or more voids and/or pores.

The polymeric core layer, prior to any extreme thermal event, may include voids and/or pores dispersed through the layer. Preferably the voids and/or pores are in the form of cells of the polymeric. As such, the polymer core layer may be foamed and/or include a foamed polymer. The amount of voids and/or pores may be sufficient so that the thermal conductivity of the thermal shielding device is reduce. Preferably, the amount of voids and/or pores in the polymeric core layer is about 3 volume percent or more, more preferably about 10 volume percent or more, even more preferably about 20 volume percent or more, and most preferably about 40 volume percent or more. The amounts of voids and/or pores in the polymeric core layer may be about 80 volume percent or less, about 70 volume percent or less, about 60 volume percent or less, or about 50 volume percent or less.

Any type of polymer may be employed in the polymeric core layer. The polymer may be a polyolefin, free of polyolefin, or a copolymer including a both an olefin and a non-olefinic monomer. The polymer may be a homopolymer or a copolymer. Examples of copolymers include random copolymers, block copolymers, graft copolymers, and alternating copolymers. Preferred polyolefin containing polymers include or consist essentially of ethylene, propylene, butene, hexene, octene, or any combination thereof. Non-polyolefin polymers include polyamides, polyimides, polyacrylates, polyesters, polyethers, polycarbonates, polyacrylonitriles, copolymers thereof, derivatives thereof, and combination thereof. The polymer may include or consist of a polystyrene. The polymer may include a polyethylene homopolymer or copolymer. Preferred polyethylene copolymers have an ethylene concentration of about 60 weight percent or more, about 70 weight percent or more, about 80 weight percent or more, about 87 weight percent or more, or about 93 weight percent or more. The polymer may include a polypropylene homopolymer or copolymer. Preferred polypropylene copolymers have a propylene concentration of about 60 weight percent or more, about 70 weight percent or more, about 80 weight percent or more, about 87 weight percent or more, or about 93 weight percent or more. Some or all of the polymer may be grafted with a functional group for improving the adhesion to a metal layer. Preferably some or all of the polymer is free of such grafts. For example, the amount of the polymer that is free of grafts may be about 70 weight percent or more, about 80 weight percent or more, about 90 weight percent or more, about 96 weight percent or more, or about 99 weight percent or more. The polymer may be a semi-crystalline polymer at 25° C. Preferred semi-crystalline polymers have a crystallinity of about 6% or more, more preferably about 10 % or more, even more preferably about 20% or more, even more preferably about 30% or more, and most preferably about 38% or more. The crystallinity may be about 80% or less, about 70% or less, or about 60% or less. Crystallinity may be measured using differential scanning calorimetry at a heating rate of 10 ° C./min, where the heat of fusion is measured and compared with the theoretical heat of fusion known for that polymer. Crystallinity=100%×H_{f}/H_{theory}.

The polymeric core layer may include multiple polymers. The multiple polymers may be in a single layer or may be in separate layers. Multiple layers of polymer may have different melting temperatures and may be employed for locating where melting and/or expansion will initially occur. For example, it may be desirable for the initial melting to occur near the center of the polymeric core layer. Here, the polymeric core layer may include multiple layers including a mid-layer interposed between two additional layers, where the mid-layer comprises a first polymer, and the two additional layers include one or more second polymers that are cross-linked and/or have a melting temperature greater than the melting temperature of the first polymer.

### Expansion

As discussed herein, one feature of the thermal shielding device may be an increase in the separation distance between the two metal layers of the device. The separation distance may be increased by a mechanical feature that is activated when the polymer in the core layer melts. The increase in the separation of the metal layers may be caused by an expansion of the core layer and/or the formation of a gas layer between two metal layers. Formation of a gas layer may be caused by one or more gas generating materials and/or one or more gas releasing materials in the polymeric core layer. The gas may be water or any other compound having a boiling point of less than about 120° C. Although the gas compound may be in a liquid phase at room temperature, it should be in gas phase at an elevated temperature, such as a temperature of the extreme temperature event.

Some or all of the gas may be i) from one or more compounds having one or more waters of hydration, ii) from a decomposition of a polymer, preferably accelerated by a catalyst, iii) from a desiccant material having water or other low boiling point compound; from a reaction of a flame retardant, or iv) from gas in an open or closed cells of a polymeric core layer (for situations where the polymeric core layer is foamed during the formation of the layer). The melting and expansion of the polymeric core layer may increase the separation distance between the first and second metal layers. The generation and/or release of gas in the polymeric core layer preferably occurs at an activation temperature Ta. The activation temperature preferably is greater than the melting temperature of the polymer by at least 30° C. (i.e., Ta≥Tm+30° C.) so that there is sufficiently large processing window for forming the polymeric core layer without activating the generation or release of the gas. More preferably, Ta≥Tm+40° C., even more preferably, Ta≥Tm+60° C., and most preferably Ta≥Tm+70° C.

Preferably, some, substantially all, or entirely all of the gas is released or generated when the polymeric core layer is heated during an extreme thermal event. For example, the amount of the gas in the polymeric core layer that is generated during the extreme thermal event may be about 10% or more, about 25% or more, about 40% or more, about 50% or more, about 60% or more, about 70% or more, about 80% or more, about 90% or more, or about 100%, based on the total amount of gas in the polymeric core layer during or following the extreme thermal event.

One or more gas molecules may be formed by the decomposition of a polymer in the polymeric core layer. As such, it may be desirable for the polymeric core layer to include a catalyst that accelerates the decomposition of the polymer. The catalyst may reduce the temperature at which the degradation of the polymer begins. The onset of degradation may be observed using thermogravimetric analysis and may be a temperature at which the mass of the polymeric core layer decreases by about 2 percent relative to the mass at a base temperature (the base temperature may be about 25° C., about 50° C., about 80° C., or about 120° C.) at a heating rate of about 10° C./min. Unless otherwise specified, the base temperature is 120° C. The onset of degradation may be measured in an air atmosphere or in an inert atmosphere. A preferred inert atmosphere is nitrogen. Unless otherwise specified, the onset of degradation is measured using an inert atmosphere of nitrogen (i.e., N₂). When employed, the catalyst preferably is used in an amount sufficient to reduce the temperature of the onset of degradation by about 20° C. or more, more preferably by about 40° C. or more, even more preferably by about 75° C. or more, and most preferably by about 100° C. or more. Any catalyst which accelerates the degradation of the polymer and the formation of gas molecules as a product may be employed. It will be appreciated that the selection of the catalyst may depend on the polymer in the polymeric core layer. Such catalysts, for example known in the field of polymer recycling, may be employed. An example of a catalyst that may be used for the degradation reaction is a zeolite catalyst. The catalyzed decomposition reaction preferably includes one or more pyrolysis reactions.

It may be desirable for the expansion of the polymeric core layer to be sufficiently low so that heat flow through the thermal shielding device is primarily via thermal conductivity. For example, heat flow via convection in the polymeric core layer may be generally prevented. Preferably the expansion of the polymeric core layer is about 1000% or less, more preferably about 750% or less, and most preferably about 500% or less so that the any heat flow via thermal convection is minimized.

It will be appreciated that different materials may generate different amounts of gas per gram of the gas releasing/gas generating material. As such, the amount of the gas releasing and/or gas generating material needed may be specified based on i) the amount of gas that is desired (e.g., in terms of moles) and/or ii) the amount of separation of the metal layers needed and/or iii) the amount of volume expansion of the polymeric core layer desired.

The amount of gas generated or released per square m² of the composite material (i.e., area measured on a face surface of a metal layer that is exposed to elevated temperature/extreme thermal event) may be about 0.01 moles/m² or more, about 0.02 moles/m² or more, about 0.05 moles/m² or more, about 0.10 moles/m² or more, or about 0.15 moles/m² or more. The amount of gas that is generated or released may be about 1.00 moles/m² or less, about 0.90 moles/m² or less, about 0.80 moles/m² or less, about 0.70 moles/m² or less, about 0.60 moles/m² or less, or about 0.50 moles/m² or less. The increase in separation of the two metal layers due do the gas preferably is about 1 mm or more, about 2 mm or more, about 5 mm or more, about 10 mm or more, about 15 mm or more, about 20 mm or more, about 25 mm or more, or about 30 mm or more.

Expansion of the thermal shielding device may be in the form of bulging of the metal layers, distancing further from each other. The bulge may have any shape. For example, the bulge may have a curved shape (e.g., on one or both metal layers), a hill shape (e.g., on one or both metal layers), an oval shape (e.g., on one or both metals), a generally flat shape (e.g., on one of the metal layers) or any combination thereof. The bulging may be localized to one or more regions of the thermal shielding device, or the bulging may be through a substantial or entire area of the thermal shielding device. As an extreme thermal event occurs, one or more regions may initially become heated and those regions may expand first. As time progresses and the thermal shielding device is further heated, the regions may expand in size and/or additional regions may expand. When the entire polymeric core layer of the thermal shielding device has become activated and released or generated gas, the maximal gap may be at or near the center of the thermal shielding device, unless the thermal shielding device is welded, bolted, or otherwise constrained in that region. Locations that are constrained, such as edge regions of the metal layers that are attached to each other or to other components may have minimal or no change in their separation. The shape of the bulging may be symmetrical or asymmetrical with respect to the two metal layers. Depending on the structure of the thermal shielding device, it may be possible to control the location of the expansion. For example, one metal layer may be relatively thin and/or be formed of a softer metal and/or have features such as pleats, wrinkles, or folds, that allow for preferred expansion of the metal layer (preferably without yielding). As another example, the two metal layers may have similar thickness, be formed of the same metal and have similar features so that the expansion is symmetric. Expansion in one direction may be limited by the presence of another component such as a housing, a frame, or a panel.

As discussed herein, the polymeric core layer may expand upon heating above a threshold temperature. Such an expansion preferably is greater than expansion due to the increased specific volume of a material as it is heated as liquid or solid and greater than an expansion due to a solid to liquid phase transition. For example, the expansion may result from a chemical reaction, and/or a phase transition from a solid or liquid to a gas phase. Preferred chemical reactions include reactions that produce a gas phase product from a solid or liquid phase reactant. Expansion of the core layer may be localized to one or more regions of the composite material or may be over the entirety of the composite material. For example, the expansion may result in one or more bulges in the composite material. A composite material that has metal layers that are initially parallel, may have metal layers that are no longer parallel in a region of a bulge. The percent expansion of the core layer may be defined by: E_{c}=100%×Δt/tᵢ, where Δt is the change in thickness of the core layer after expansion (e.g., at its thickest location and/or location that has expanded the most) and tᵢ is the initial thickness of the core layer. If the expansion of the core layer is too low, the composite material may not offer sufficient improvement in slowing the flow of thermal energy through the composite material. The percent expansion of the core layer, E_{c}, may be about 5 percent or more, about 10 percent or more, about 20 percent or more about 40 percent or more, about 60 percent or more, about 80 percent or more, or about 100 percent or more. If the percent expansion of the core layer is too high, convective heat flow may become a problem. The percent expansion of the core layer may be about 1000% percent or less, about 900 percent or less, about 800 percent or less, about 700 percent or less, about 600 percent or less, or about 500 percent or less.

### Blowing Agent

Examples of blowing agents that may be employed include chemical blowing agent and hydrates. The blowsing agent may be a foaming agent. The chemical blowing agent may be any compound that reacts during the extreme thermal event to produce a gas at the elevated temperature. Examples of chemical blowing agents include azodicarbonamides and sodium bicarbonate. The gas may also be formed by the reaction of monomers, such as during a condensation reaction, whereby water, carbon dioxide or other low boiling point molecules are formed.

A hydrate including one or more waters of hydration. The water typically is bonded to a metal or a metal containing base compound. The compound may have hydrated water, coordinated water, or both. Examples of based compounds includes metal salts, metal halides, metal carbonates, alkaline metal sulfates, alkaline metal halides, alkaline metal carbonates, alkaline earth metal sulfates, alkaline earth metal halides, alkaline earth metal carbonates, or any combination thereof. Preferred alkali metals include K and Na. Preferred alkaline earth metals include Ca and Mg. Preferred halides include bromides and chlorides. The meal salt, metal halides, metal carbonates Preferred metals include Cr, Mn, Fe, Co, Ni, Cu, Cd, V, Al, Mg, or any combination thereof. The number of waters of hydration per molecule (or per metal atom) may be one or more, two or more, three or more, four or more, five or more, or six or more. Some or all of the waters of hydration may be released during an extreme thermal event. The number of waters of hydration released may be one or more, two or more, three or more, four or more, or five or more. A compound having two or more waters of hydration may release or generate water at different temperatures.

By way of example calcium chloride is a hygroscopic salt that can be anhydrous, or have 1, 2, 4 or 6 waters of hydration. The hexahydrate form will convert to the tetrahydrate form at about 30° C., giving off two waters of hydration. The tetrahydrate will convert to the dihydrate at a temperature of about 46° C., giving off two waters of hydration. The dihydrate will convert to the monohydrate at a temperature of about 175° C., giving off one water of hydration. The monohydrate will convert to the anhydrous compound at a temperature of about 260° C., giving off the last water of hydration. The hexahydrate and tetrahydrate compounds will generally give off water at the processing temperature of the polymer. This may be advantageous when producing a polymeric core layer that is foamed. Depending on the selection of the polymer, other waters of hydration may be given off during the processing of the polymer. However, it may be possible to prepare a polymeric core layer with the dihydrate (e.g., starting with the dihydrate, or starting with a tetrahydrate or hexahydrate and having some of the waters of hydration removed), provided that the layer is formed at a temperature less than 175° C. Similarly, a polymeric core layer may be formed with the monohydrate form, provided that the layer is formed at a temperature less than 260° C. If the polymeric core layer includes the dihydrate, one water of hydration will be released when the material reaches a temperature of about 175° C. and the last water of hydration will be released when the temperature increases to about 260° C.

The polymeric core layer may include a desiccant material having water. If employed, the desiccant preferably is provided with or charged with a predetermined amount of water. Although some of the water may be released during the formation of the polymeric core layer (such as discussed herein with respect to compounds having a water of hydration), it is preferred that some or all of the water is remaining in the desiccant after the polymeric core layer is formed. The water in the desiccant in the polymeric core layer may be released following a extreme thermal event as the polymeric core layer is heated. Examples of desiccants include molecular sieves, silica gel, anhydrocel (CaSO4), Anhydrone (Mg(ClO4)2), Ascarit, Desicchlora (Ba(ClO4)2), alumina (Al2O3), Mikohbite (68% NaOH, 32% fluffed mica), magnesium perchlorate, barium oxide, phosphorous pentoxide, lithium perchlorate, calcium chloride, sodium hydroxide, barium perchlorate, calcium oxide, magnesium oxide, and potassium hydroxide. Examples of molecular sieves includes zeolites.

In some cases, the release of water by a hydrate or by a desiccant will be an endothermic reaction. As such, the some of the thermal energy of the extreme thermal event will be consumed in generating the water. This can be useful in slowing the flow of heat through the thermal shielding device.

The polymeric core layer may be formed as a foamed core layer. Here, the thickness of the core layer increases with temperature (° K.), such as a linear increase in volume according to ideal gas law. As the area of the thermal shielding device may be generally fixed, the expansion may be in the thickness direction, resulting in a thickness that increases generally linearly with temperature in ° K.

The polymeric core layer may include one or more flame retardants (i.e., flame retardant compound). The flame retardant may be a halogen containing flame retardant or may be a halogen free flame retardant. Any flame retardant that suppresses the combustion of the polymer in the core layer. Preferred flame retardants generated a gas (e.g., at a temperature above the critical temperature during an extreme thermal event) and/or have an endothermic reaction that consumes thermal energy. Examples of flame retardants include mineral flame retardants, organohalogen compounds, organophosphorus compounds, inorganic phosphate compounds, organic phosphate compounds, and graphene. Examples of minerals that may be employed as a flame retardant include aluminum hydroxide, magnesium hydroxide, huntite, hydromagnesite, red phosphorous, boron compounds, or any combination thereof. The boron compound may be a borate. Examples of organohalogen compounds include organochlorines and/or organobromines. Preferably, the organohalogen is used with a synergist, such as an antimony containing compound. Preferred synergists include antimony oxide, antimony pentoxide, and sodium antimonate. Examples of organophosphorus compounds include organophosphates, phosphonates, and phosphinates. The organophosphorus compound may include a halogen, preferably a chlorine or a bromine. Other organophosphorus compounds are halogen free. It may be desirable that the flame retardant is halogen free so that exposure to halogenated decomposition products is reduced or eliminated.

The flame retardant preferably prevents the polymer from burning for a period of time. For example, when one metal layer is exposed to a direct flame, the delay of burning of the polymer, may allow the other metal layer to remain at a temperature of 600° F. or less for 5 minutes or more, preferably for 7 minutes or more, and most preferably for 10 minutes or more.

The polymeric core layer may include a reinforcing filler. Preferred reinforcing fillers are mineral fillers. The polymeric layer may include metal fibers or metal particles. Metal fibers or metal particles in the polymeric core layer may increase the thermal conductivity of the core layer. Preferably the amount of metal fibers and metal particles in the polymeric core layer is sufficiently low so that the thermal conductivity of the layer is about 2.00 W/mK or less, preferably about 1.00 W/mK or less, and more preferably about 0.80 W/mK or less. Preferably the amount of metal in the polymeric core layer is about 10.0 volume percent or less, more preferably about 6.0 volume percent or less, even more preferably about 3.0 volume percent or less, and most preferably about 2.0 volume percent or less. The polymeric core layer may be entirely free or substantially free (for example 1.0 volume percent or less or 0.5 volume percent or less) of metal.

The composite material may be free of welds, bolts or other connectors that limit the ability of the core material to expand in regions for which thermal shielding is most desired. Bolts, welds, connectors preferably are located in regions away from shielding region. For example, connections through both metal layers may occur at a periphery region or edge region of the composite material. May occur at an extension region, where the composite material extends into a region away from a heat source. Bolts, welds, connectors in a shielding region may attach to only one of the metal layers, so that the distance between the metal layers is not constrained by the connector. As such, it may be possible for the core layer to expand, even though one of the metal layers is connected to another component.

One or meltable connectors may be used to connect the first metal layer and the second metal layer. The meltable connector may melt during an extreme thermal event so that first and second metal layers can separate from each other. A meltable connector may include or be formed of a polymer that melts at any of the temperatures described herein for the core layer. A meltable connector may include or be formed of a polymer described herein for the core layer.

### Edge Sealing

The two or more metal layers may be sealed together, typically along one or more edges. Sealing of the edges may improve the ability of the composite material to expand and retain gas that is generated or released during an extreme thermal event. The two metal layers may be sealed by joining them together directly or indirectly. For example, the tow metal layers may be joined together using a third metal layer. As another example, one of the metal layers may have an extension region that is bent to reach or cover the other metal layer so that the two metal layers may be directly attached. As another example, there may be a region that is free of the polymeric core layer near the edge of the metal layer, so that the faces of the two metal layers in that region can be contacted together and joined.

It will be appreciated that an edge region may be located sufficiently far from heat generated from the extreme thermal event that the polymeric core layer functions as a seal in the edge region. As such, there may be no need to seal or join together the two metal layers in order to achieve expansion of the core layer, particularly where the expansion is localized to one or more regions (e.g., away from an edge).

FIG. 5 illustrates an example of a shielding device including metal outer layers and separated by a layer including one or more gas generating the material. The gas generating material may be a material that generates or releases gas upon being heated. The gas creates an outward pressure on the metal layers causing them to separate. In some cases, it may be necessary for one or more, or even all of the edges of the metal layers to be sealed together to reduce or prevent the escape of the gas. The separation of the metal layers may be local at one or more regions, or may be over essentially the entire area of the metal layer. It will be appreciated that edges that are sealed together may be difficult to expand. However, if both expansion and sealing at the edges are needed, the sealing of the edges can be achieved using one or more edge expansion components that allow the height of the seal (i.e., the distance between the two metal layers at the edge) to increase. For example, the seal may include one or more folds, pleats, grooves or other structure that can expand at low forces. For example, when the core layer is in a melt state (above its glass transition temperature and above its melting temperature) the expansion component of the edge seal may require a force of less than 25% of the yield stress of the metal layer in order for the height of the seal to increase. The edge expansion component may allow the height of the edge to increase by about 5% or more, about 15% or more, about 35% or more, about 70% or more, about 100% or more, about 175% or more, or about 250% or more.

Attachment of the thermal shielding device may employ any attachment component or method used for attaching metals and/or composite materials. Examples of attachments include welding, bolts, and rivets. The attachment may use one of the metal layers or both of the metal layers.

The thermal shielding device may be attached to a device capable of generating thermal energy. The thermal shielding device may be attached to an assembly, frame or panel so that it is positioned over a device capable of generating thermal energy.

In many applications the thermal shielding device will be attached or mounted to an assembly, frame or panel. When the thermal shielding device is mounted it may be difficult for the device to expand at the regions where it is attached. It may be possible to attach the thermal shielding device only at positions where expansion is not as important. For example, the thermal shielding device may be attached only at or near edge regions, at or near extension regions, at or near bent portions, or any combination thereof. The thermal shielding device may include one or more extension regions, such as illustrated in FIG. 7. The extension region may be a region where shielding is needed. The extension region may be used for attaching the thermal shielding device. When the extension region is used for attaching the thermal shielding device, it preferably is in a location where shielding is not needed or where reduced thermal shielding is needed.

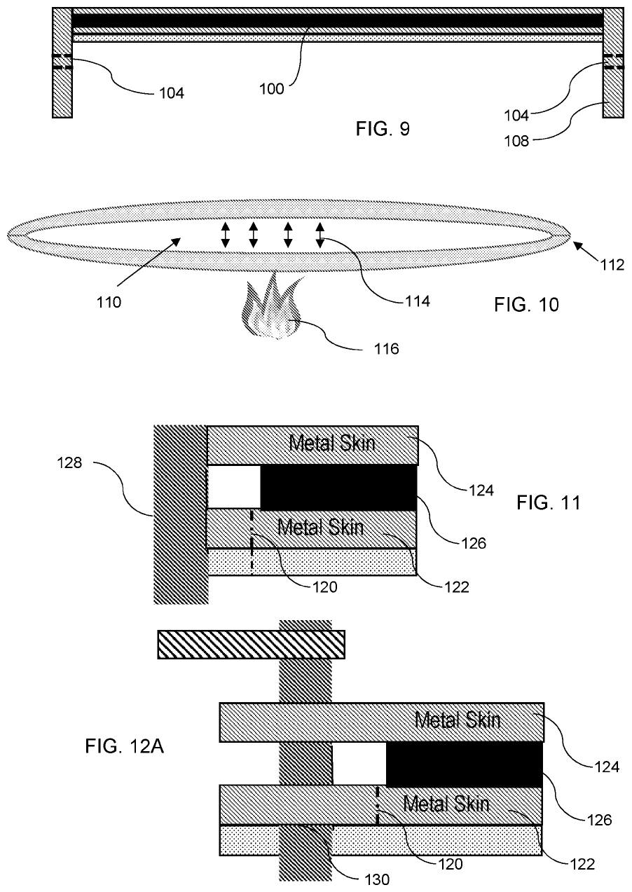

The thermal shielding device includes one or more shielding regions 100 where the device helps to reduce the flow of thermal energy. The shielding region preferably includes or consists of a composite material or laminate according to the teachings herein. The thermal shielding device may include one or more extension regions 102. Although the thermal shielding device may also function to reduce the flow of thermal energy in the extension region(s), the requirement for thermal shielding in these regions typically is reduced. The extension region may be employed for attaching the thermal shielding device to an assembly, a panel, a frame, or other component. The extension region may include the same material (e.g., composite material) as the shielding region, or may be formed of a different material. As illustrated in FIG. 7, an extension region 102 may be used as an attachment location 104. An attachment location 104 may be located in an edge region 106 of the thermal shielding device, such as illustrated in FIG. 8. Preferably the edge region is about 150 mm or less, about 100 mm or less, about 50 mm or less, or about 25 mm or less from an edge of the heat shielding device. An extension region may include a bent portion or a protrusion angled relative to a shielding region. The bent portion or protrusion 108 may be generally perpendicular to the shielding region 100, such as illustrated in FIG. 9. The bent portion or protrusion 108 may be formed of the same material or of a different material as the shielding region 100. For example, a protrusion 108 may be formed of a generally monolithic material, such as illustrated in FIG. 9.

It may also be possible to attach the thermal shielding device using only one of the metal layers. Here, the attached layer is in a generally fixed position and the other layer may be able to move from the attached layer.

Gas in the polymeric core layer (e.g., before expansion and/or after expansion) and/or in the space between the metal layers preferably is substantially free of oxygen molecules (i.e., 0₂). The amount of oxygen molecules in the polymeric core layer and/or in the space between the metal layers preferably is about 24 percent or less, more preferably about 18 percent or less, even more preferably about 10 percent or less, even more preferably about 5 percent or less, and most preferably about 1 percent or less, based on the total number of gas molecules in the polymeric core layer. The amount of oxygen molecules may be about 0 percent or more.

The separation of the metal layers may be by the action of a spring. For example, the device may include one or more springs in a non-equilibrium state (a compressed or elongated state). Preferably the spring is in a compressed state. The spring is prevented from returning to an equilibrium state by one or more components of the device. For example, the spring may be embedded in a polymer which is in a solid state. The polymer in a solid state may be a semi-crystalline polymer which is below its melting temperature and/or crystallization temperature. The polymer in a solid state may be a glassy polymer which is below its glass transition temperature. During its use, the polymer preferably remains in a solid state until it is exposed to a sufficiently high temperature that activates the expansion feature of the device. Here, the expansion feature may be activated by the melting or softening of the polymer. This may include heating the polymer to a temperature at or near its melting temperature (e.g., to a temperature of at least about Tₘ−10° C., about Tₘ, about Tₘ+30° C., about Tₘ+40° C., about Tₘ+50° C., about Tₘ+60° C., or about Tₘ+80° C.). The heating of the polymer allows the spring to return toward its equilibrium length and applies a force to separate the metallic layers.

During an extreme thermal event, the thermal shielding device may be exposed to heat, typically from a heat source 116 located on one side of the device. The heat causes gas generation in the core layer and/or gas expansion in the core layer. The core layer including the gas 110 applies a pressure 114 onto the metal layers. The metal layers may then separate from each other, typically with an increase in the thickness of the core layer 110. It will be appreciated that in addition to, or instead of the core layer expanding, a separate gas phase may form between the two metal layers. The two metal layers may be sealed together 112 to prevent gas from escaping at an edge, such as illustrated in FIG. 10.

The thermal shielding device may include a break point, such as a perforation, scoring, thinned region, or other feature that results in one of the metal layers breaking at a predetermined location. The breaking of the metal layer may occur due to pressure generated in the core layer, such as during an extreme thermal event. It will be appreciated that the break point may include one or more points, may include one or more generally straight lines, or may include one or more generally curved lines. A break point may be used to aid in the separation of the metal layers. The break point preferably is at or near an edge region of the thermal shielding device. A break point may particularly be used when the edge region is sealed (e.g., when the two metal layers are welded or otherwise joined together). The thermal shielding device may have one metal layer that is a fixed layer and one metal layer that becomes movable after being broken, so that it can move away from the fixed metal layer. A thermal shielding device having a break point is illustrated in FIG. 11. With reference to FIG. 11, a metal layer 122 and/or a barrier layer including a break point 120 may be attached to a fixed metal layer 124. The attachment may be via an edge region component 128. It will be appreciated that the edge region component is formed from one of the metal layers, or is formed from a different part. The thermal shielding device preferably includes a core layer 126 which preferably generates and/or releases gas upon being heated. The core layer 126 may extend to the edge region component 128 or there may be a gap in the edge region where there is no core layer material. For example, the core layer material may end before or at the break point, such as illustrated in FIG. 6. A break at the break point may occur due to the pressure of the gas in the core layer, such as during an extreme thermal event. Examples of breaking points include perforations, scoring, notched regions, and thinned regions.

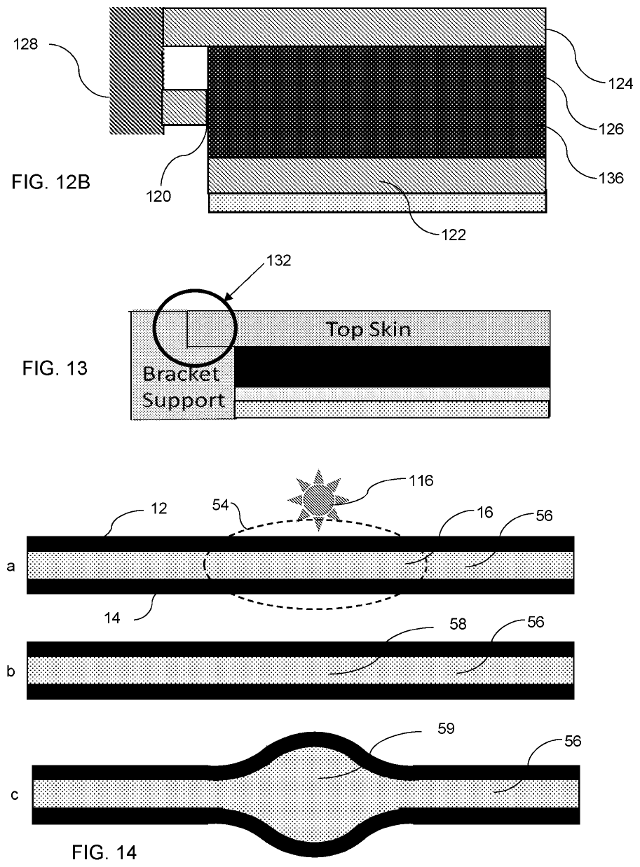

FIGS. 12A and 12B illustrate a thermal shielding device attached at an edge region and including one or more features for breaking at a predetermined location. FIG. 12A shows the structure prior to breaking of the metal layer 122 and FIG. 12B shows the structure after the breaking of the metal layer 122 and/or the barrier layer, where this layer has moved away from a fixed metal layer 124. The thermal shielding device may be attached to another component using an attachment component 130. The attachment component may also attach both metal layers of the composite material together. After the core layer expands 136, the movable metal layer 122 may break at the breaking point and move away from the fixed metal layer 124, particularly in a shielding region. Although the core layer is shown ending before or near the break location, it may extend past the break location or even to the edge.

The thermal shielding device may be connected to an assembly, a panel, a frame, or other component 133 using a connector or attachment component 132, such as illustrated in FIG. 13. The connector or attachment component may be connected to both of the metal layers. Preferably, the connector or attachment component is connected to only one of the metal layers, so that there is a fixed (or connected metal layer) and a movable metal layer that moves after an extreme thermal event.

It will be appreciated that that an extreme thermal event may result in separation of the metal layers only in one or more regions, such as illustrated in FIG. 14. For example, the thermal energy may cause only local melting and/or only local generation or release of gas.

Heat 116 on one or both sides of the thermal shielding device may initially heat a first region 54 of the polymeric core layer.

In one aspect, the core layer initially includes a polymer in a solid state 56 (e.g., having crystallinity and/or below its glass transition temperature. As the polymer is heated it melts and/or softens and is in a liquid state 58, preferably above its glass transition temperature and without any crystalline phase. The melting and/or softening may be localized to a region being heated.

Gas may be released or generated in a heated region when the temperature reaches a critical point, or activation temperature. The gas may cause the core layer to expand 59 in the heated region 54. The expansion may be on one or both sides of the thermal shielding device. The expansion may be symmetrical. The heated region 54 may expand over time with additional heating. Because of the size of the thermal shielding device, there may be regions where the core layer is still in a solid state 56, even when the core has expanded (e.g., by 25% or more, 50% or more, 75% or more, or 100% or more) in the heated region 54. The expanded core layer 59 results in a separation of the metal layers 12, 14 at or near the heated region 54.

The thermal shielding device may include one or more components in the core layer 16 for storing potential energy 80. Upon heating (e.g., upon melting or softening) the polymer, the stored potential energy is released, causing the core layer to expand and a separation distance 90 between the metal layers 12, 14 to increase. The potential energy may be stored in one or more springs 82, such as illustrated in FIG. 15. The springs may be spaced apart, preferably throughout the area of the thermal shielding device. The springs preferably are arranged so that the thickness of the core layer and/or the spacing between the metal layers increases when the polymer melts or softens and the spring returns from a compressed state towards an uncompressed state.

One or more features may be used to cause the separation distance 90 between the metal layers to increase during an extreme thermal event.

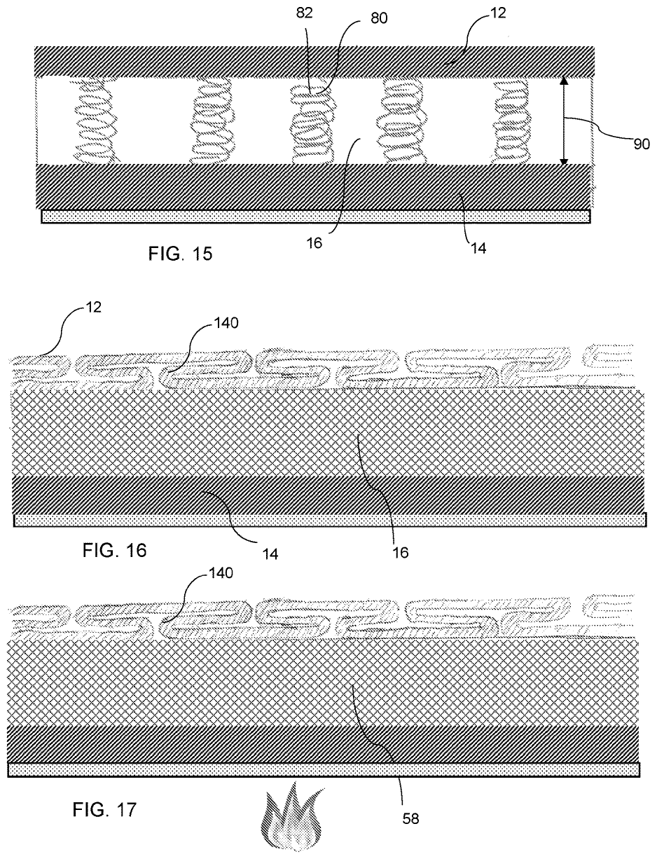

One or both of the metal layers 12, 14 may include one or more features that allows the layer to expand (e.g., in length, width, or area), preferably without yielding the metal material. For example, the metal layer may include one or more folds 140, creases, wrinkles or pleats, such as illustrated in FIG. 16.

Upon heating a region of the thermal shielding device, a portion of the polymer in the core layer may become molten and/or soften 58, such as illustrated in FIG. 17.

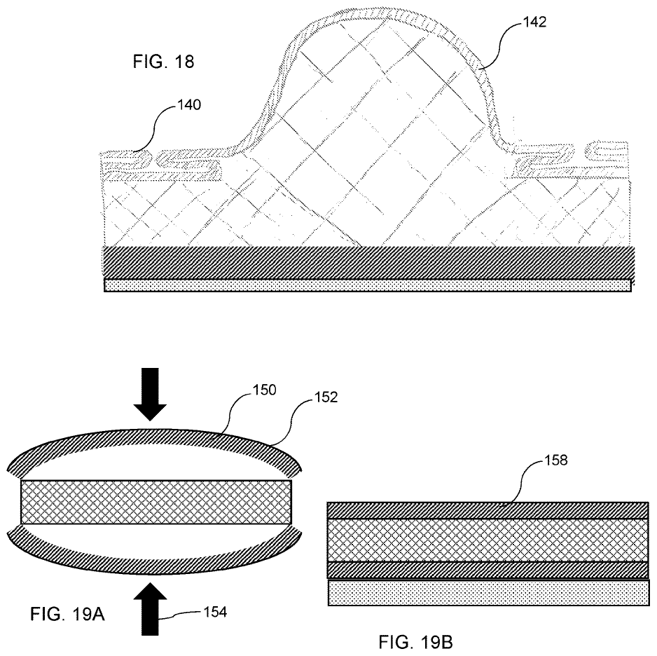

As the metal layers separate, a metal layer may expand 142 in area by removing some or all of the folds, wrinkles, creases or pleats, such as illustrated in FIG. 18. This allows the metal layers to separate in a region without the metal layer stretching and yielding.

The thermal shielding device may have potential energy from a metal layer (or both metal layers) being in a compressed state 158. For example, one or more metal layers may have a curved configuration 150 prior to forming the thermal shielding device. During the forming of the device, the metal layer may be compressed 154 and is held in a compressed state, e.g., by the core layer. Upon melting or softening of the polymer in the core layer, the metal layer may return back towards its curved and/or uncompressed configuration. This may cause an increase in the thickness of the core layer and or an increase in a separation distance of the metal layers. FIG. 19A illustrates metal layers that are curved, prior to forming the thermal shielding device. FIG. 19B shows the thermal shielding device with the metal layers in a compressed state. The metal layers may be maintained in a flattened orientation by physical or mechanical means. For example, the metal layers may be adhered to the core layer. As another example, the layers may be attached via one or more connectors (e.g., in central regions of the thermal shield device). Connectors preferably are meltable connectors. It will be appreciated that the flattened orientation should be reversed upon heating, such as in an extreme thermal event. In the uncompressed state, such metal layer(s) preferably has an outer surface that is convex 152.

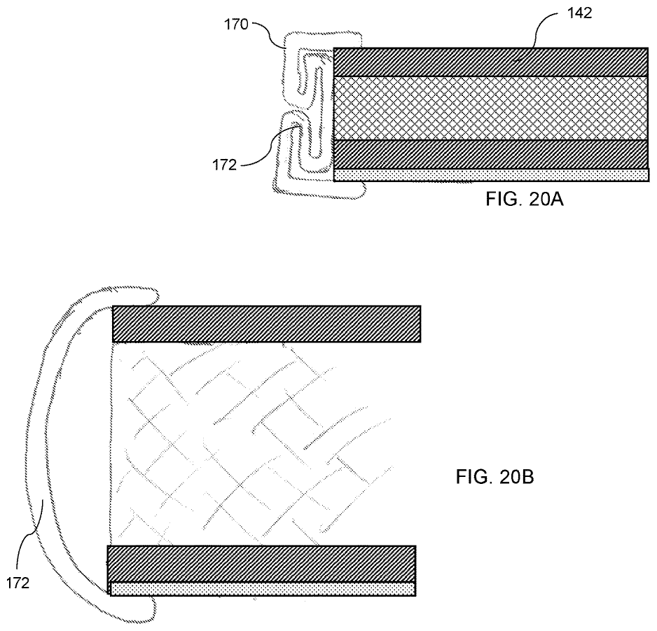

An edge of the thermal shielding device may be covered with an edge covering component 170. The edge covering component may be capable of expanding (preferably without yielding) when the thickness of the core layer increases and/or a separation distance of the metal layers increases. For example, the covering component may include one or more folds, wrinkles, pleats, or creases 172, such as shown in FIG. 20A. When the core layer expands 174, one or more of the folds, wrinkles, pleats, or creases may be at least partially removed so that the edge covering component can expand without yielding. Preferably, the edge covering component maintains contact with the metal layers and/or seals the edge prior to and during expansion of the core layer.

The thermal shielding device may also assist in providing EMI shielding to one or more components.

The thermal shielding device preferably has good sound dampening properties as characterized by a composite loss factor of about 0.010 or more at a temperature of about 50° C. and a frequency of about 100 Hz.

### Battery and/or Electric Vehicle (i.e., EV)

The thermal shielding device according to the teachings herein may be employed in a system including a battery. The thermal shielding device may shield a compartment from the battery when an extreme thermal event occurs from the battery or affecting the battery. For example, the battery may be in an electric vehicle and the thermal shielding device may shield a compartment of an EV. The electric vehicle may be a hybrid EV or a plug-in EV. Preferably the battery provides power for an electric motor that drives the vehicle. The EV preferably is free of an internal combustion engine. The battery may include one or more battery cells for providing power.

The thermal shielding device may be arranged in a generally horizontal direction, so that a face surface of the thermal shielding device generally faces towards the vertical direction. Preferably a barrier layer of the thermal shielding device faces upward in the vertical direction. Preferably, the thermal shielding device is at least partially located below a passenger compartment, at least partially below a seat, at least partially below a trunk, at least partially below a frunk, or any combination thereof.

The thermal shielding device may be used as a cover of a battery, a housing of a battery, or may be a separate component spaced apart from the battery. The thermal shielding device may shield any vehicle compartment from the battery. The compartment shielded by the thermal shielding device may include a storage area, a computer or other electronic controls, or a passenger area. Preferably the thermal shielding device shields a passenger compartment. The compartment may be above the battery, below the battery, in front of the battery, or behind the battery. As discussed herein, the thermal shielding device reduces heat flow through the device and thus may reduce heat flow into the shielded compartment. The battery cover may be arranged over or in front of one or more battery cells. The battery cover may be generally horizontal, angled, or generally vertical.

The thermal shielding device may be generally flat. The thermal shielding device may be formed from a flat sheet having a uniform thickness and/or a planar surface. For example, the thermal shielding device may be formed by pressing or stamping. The thermal shielding device may have one or more regions with a planar surface. The thermal shielding device may have a surface including regions (or entirely) having a shape that is similar to a housing of a battery. There may be a gap above, or below the battery cover (e.g., for a generally horizontal battery cover). There may be a gap in front of, or behind the battery cover (e.g., for a generally vertical battery cover). A gap may between the battery and the battery cover and/or between the battery cover and a passenger compartment.

A laminate according to the teachings herein (e.g., including metal layers and a core layer) having a barrier layer may be processed into a thermal shielding device using a method comprising one or any combination of the following steps: cutting a sheet or roll of the laminate into a predetermined length; cutting a blank from the sheet or roll of the laminate; stamping or otherwise forming the blank (e.g., so that it has a non-planar shape); sealing or rolling an edge of the laminate; or cutting one or more holes in the laminate or blank (e.g., for attaching the laminate to a component or structure).

The thermal shielding device may be attached to a frame of a vehicle or to a panel of a vehicle. The thermal shielding device may be attached to a container (e.g., a housing) that hold one or more battery cells. The thermal shielding device may be oriented so that it provides a barrier between a device that generates heat (e.g., during an extreme thermal event) and the compartment or area being shielded. The thermal shielding device may be sufficiently large so that it provides a substantial or complete barrier to the compartment or area being shielded.

What is claimed is:

1. A thermal shielding device comprising:
i. a first metal layer;
ii. a second metal layer;
iii. a core layer (preferably an expandable core layer) interposed between the first metal layer and the second metal layer; and
iv. a barrier layer that provides a thermal barrier (e.g. thermal insulation), an electrical barrier (e.g., electrical insulation), or both;
optionally wherein the thermal shielding device has a thermal conductivity of about 0.015 to about 4 W/mK, and upon heating to a temperature of about 100° C. or more, the core layer causes a separation distance between the first and second metal layers to increase in one or more regions and a thickness of the thermal shielding device to increase by about 15 percent or more in the one or more regions.

2. The thermal shielding device of claim 1, wherein the barrier layer is directly adjacent to the first metal layer or the barrier layer is attached to the first metal layer.

3. The thermal shielding device of claim 2, wherein the barrier layer is attached to first metal layer with an adhesive, optionally a pressure sensitive adhesive.

4. The thermal shielding device of claim 1, wherein the core layer and the first metal layer are interposed between the second metal layer and the barrier layer, optionally wherein the layers are arranged in the following sequence:
the barrier layer, the first metal layer, the core layer, and the second metal layer.

5. The thermal shielding device of claim 1, wherein the barrier layer is an outside layer of the device facing towards one or more battery cells.

6. The thermal shielding device of claim 2, wherein the barrier layer and the core layer are interposed between the first metal layer and the second metal layer, wherein the layers are arranged in the following sequence: the first metal layer, the barrier layer, the core layer, and the second metal layer.

7. The thermal shielding device of claim 1, wherein the barrier layer includes an aerogel; optionally wherein the aerogel is a intumescent material,
wherein the volume expansion of the aerogel upon heating to a temperature of about 200° C. or more about 200% or more, about 300% or more, about 400% or more, or about 500% or more;
optionally wherein the aerogel includes a carbon aerogel, a silica aerogel, an alumina aerogel, a chromia aerogel, a graphene aerogel, or a tin oxide aerogel;
optionally wherein the aerogel has a thermal conductivity of about 0.040 W/mK or less, measured at about 23° C.

8. The thermal shielding device of claim 1, wherein the barrier layer includes a composite material comprising inorganic fibers;
optionally wherein the inorganic fibers include glass fibers and the composite material comprises a silicon rubber.

9. (canceled)

10. (canceled)

11. The thermal shielding device of claim 1, wherein the barrier layer includes one or more inorganic compounds;
optionally wherein the one or more inorganic compounds includes an aluminum silicate.

12. (canceled)

13. (canceled)

14. (canceled)

15. The thermal shielding device of claim 1, wherein the barrier layer includes a flame retardant coating, comprising a carbon powder additive;
optionally, wherein the flame retardant coating has fire endurance on aluminum of 6 hours or more, when tested at 700° C.

16. The thermal shielding device of claim 1, wherein the core layer includes an expandable graphite.

17. (canceled)

18. (canceled)

19. (canceled)

20. (canceled)

21. The thermal shielding device of claim 1, wherein the core layer is a polymeric core layer including:
i) a first additive selected from the group of a flame retardant compound and a gas generating compound; or
ii) a second additive selected from the group consisting of an antioxidant, a reinforcing filler and a mineral filler;
preferably wherein the polymeric core layer includes the first additive and the second additive;
optionally wherein the generating compound generates a gas (preferably, carbon dioxide or water) at a temperature of about 100° C. to about 320° C.

22. (canceled)

23. (canceled)

24. The thermal shielding device of claim 1, wherein the first metal layers and the second metal layers are formed of different materials, wherein the different materials are a steel and an aluminum;
wherein a ratio of a thickness of the second metal layer to a thickness of the first metal layer is about 1.4 or more.

25. (canceled)

26. (canceled)

27. A battery cover for a plug-in electric vehicle comprising a thermal shielding device of claim 1.

28. (canceled)

29. A system comprising
the battery cover of claim 27,
an electric motor for driving one or more wheels of a vehicle;
one or more battery cells for providing power to the electric motor;
wherein the battery cover is arranged over one or more of the battery cells,
preferably wherein the battery cover is generally horizontal;
optionally wherein the battery cover is attached to a container that holds one or more battery cells and/or the battery cover is attached to a vehicle body and arranged below a passenger compartment;
optionally wherein the system includes a gap above or below the battery cover for allowing a separation of the first and second metal layers to increase;
optionally, wherein the battery cover is arranged so that the barrier layer faces towards the one or more battery cells;
optionally, wherein the barrier layer has a sufficiently high electrical resistivity to prevent or reduce arcing or other electrical failure.

30. (canceled)

31. (canceled)

32. A material system comprising
a composite material including:
i. a first metal layer;
ii. a second metal layer; and
iii. a core layer (preferably an expandable core layer) interposed between the first metal layer and the second metal layer;
wherein the material system includes a barrier layer that provides a thermal barrier (e.g. thermal insulation), an electrical barrier (e.g., electrical insulation), or both.

33. The material system of claim 32, wherein the barrier layer is provided as a separate material, and the composite material is in the form of a coil, wherein each winding of the coil is sufficiently ductile so that it can be stamped after unwinding.

34. (canceled)

35. (canceled)

36. (canceled)

37. (canceled)

38. (canceled)

39. A method of applying the material system of claim 33 to a battery comprising a step of positioning the barrier layer over a housing including one or more battery cells, positioning the composite material over the barrier layer, and attaching the composite material to the housing.

40. The thermal shielding device of claim 1, wherein the thermal shielding device includes a high resistivity coating, optionally wherein the high resistivity coating includes a thermoplastic composition including a polyvinyl chloride (PVC).

41. (canceled)

42. The thermal shielding device of claim 40, wherein the thermoplastic composition is applied as a coating including one or more solvents, preferably wherein the one or more solvents including one or more aromatic solvents, one or more alcohols, one or more ketones, one or more alkanes, or any combination thereof, more preferably wherein the solvent includes one, two, three, four, or all of toluene, phenol, an n-alcohol having 3 to 6 carbon atoms (preferably having 3 or 4 carbon atoms), ethyl alcohol, and a ketone (e.g., a branched ketone);
optionally wherein the thermoplastic composition includes a plasticizer;
optionally wherein the concentration of the plasticizer is sufficiently high so that the barrier layer can be processed by stamping, bending, drawing, or other forming process without fracture or delamination of the barrier layer;
optionally, wherein the thermoplastic composition including the PVC comprises a flame retardant, a charring agent, or both;
optionally, wherein the total concentration of the PVC, the flame retardant and/or charring agent. and any plasticizer is about 98 weight percent or more.

43. (canceled)

44. (canceled)

45. (canceled)

46. (canceled)
